(19) United States
(12) Patent Application Publication
(10) Pub. No.: US 2006/0100726 A1
(43) Pub. Date: May 11, 2006

(54) Digital audio amplifier, an audio system including the same, and a method of amplifying an audio signal

(75) Inventors: Il-Joong Kim, Yongin-si (KR); Jeoung-In Lee, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/268,420

(22) Filed: Nov. 7, 2005

(30) Foreign Application Priority Data
Nov. 8, 2004 (KR) 2004-90386

(51) Int. Cl. G06F 17/00; H04H 5/00

(52) U.S. Cl. 700/94; 381/2

(57) ABSTRACT

A digital audio amplifier, an audio system including the same and a method of amplifying an audio signal that can reduce switching noise interference generated in a pulse width modulator are provided. The digital audio amplifier includes a selection circuit, a digital signal processor and a pulse width modulator. The selection circuit selects one of an audio data signal and a digitized broadcasting signal to output a digital input signal. The digital signal processor samples the digital input signal using one of a plurality of oversampling frequencies based on a local oscillator output signal and a separation signal to output a sampled digital signal. The pulse width modulator performs a pulse width modulation on the sampled digital signal.

### CROSS-REFERENCE TO RELATED APPLICATION

This application claims priority under 35 U.S.C. § 119 to Korean Patent Application No. 2004-90386, filed on Nov. 8, 2004, the disclosure of which is incorporated by reference herein in its entirety.

### BACKGROUND OF THE INVENTION

1. Technical Field

The present invention relates to a digital audio amplifier, and more particularly, to a digital audio amplifier capable of reducing the interference of switching noise, which is generated in a pulse width modulator, with an incoming broadcasting signal, an audio system including the same and a method of amplifying an audio signal for reducing the switching noise interference.

2. Discussion of the Related Art

An audio amplifier is generally implemented as a pulse width modulated (PWM) amplifier operating at a switching frequency of over 100 kHz and is typically called a class-D amplifier. When a class-D amplifier performs a switching operation at such a frequency, the frequency at which the switching is performed and its harmonics may interfere with nearby electronic devices.

For example, when a class-D amplifier performs a switching operation at a frequency of over 100 kHz, the class-D amplifier may generate harmonics that interfere with the reception of an amplitude modulation (AM) radio receiver that is located near the class-D amplifier. In addition, since the frequency of a PWM signal that is used in a class-D amplifier may overlap with that of an AM radio broadcasting signal, the PWM signal and its harmonics may interfere with the AM signal. Because of this, a class-D amplifier is typically not used in electronic products having components that may be affected by switching noise.

Recently, studies have been directed to reducing switching noise interference in analog and digital pulse width modulators.

FIG. 1 illustrates one example of a conventional audio system disclosed in U.S. Pat. No. 6,768,376 having an analog class-D amplifier that reduces switching noise interference. Referring to FIG. 1, the audio system includes an AM receiver 20 and a class-D amplifier 10. The class-D amplifier 10 is an analog amplifier, and has a harmonic-avoidance modulator 12. A local oscillator signal used in the AM receiver 20 has a frequency of, for example, (a received AM signal +450 kHz). The local oscillator signal provides information about the frequency to be avoided to the harmonic-avoidance modulator 12. As a result, the conventional audio system enables incoming signals to be subject to less interference from switching noise that is generated in the analog audio amplifier.

In another example, Korean Patent Application Publication No. 2003-26108 discloses a method for reducing switching noise interference in a digital audio amplifier. For example, when there is interference with an AM broadcasting signal resulting from switching noise generated by the digital audio amplifier, the digital audio amplifier changes the frequency of a PWM signal from 384 kHz to 384/2 kHz. However, by changing the frequency of the PWM signal to 384/2 kHz, the characteristics of amplified audio signals that are output from the digital audio amplifier may be deteriorated.

Accordingly, there is a need for a method of reducing the interference of a PWM signal in a digital audio amplifier with a received broadcasting signal without deteriorating the characteristics of an amplified audio signal.

### SUMMARY OF THE INVENTION

In an exemplary embodiment of the present invention, a digital audio amplifier includes a selection circuit, a digital signal processor and a pulse width modulator. The selection circuit selects one of an audio data signal and a digitized broadcasting signal to output a digital input signal. The digital signal processor samples the digital input signal using a plurality of oversampling frequencies based on a local oscillator output signal and a separation signal to output a sampled digital signal depending upon whether noise, which is generated from a fundamental frequency component and harmonics components of a pulse width modulation signal, interferes with a carrier frequency of the broadcasting signal. The pulse width modulator performs a pulse width modulation on the sampled digital signal.

In another exemplary embodiment, an audio system includes a receiver and the above described digital audio amplifier.

In still another exemplary embodiment, a method of amplifying an audio signal includes selecting one of an audio data signal and a digitized broadcasting signal to output a digital input signal; determining whether noise, which is generated from a fundamental frequency component and harmonics components of a pulse width modulation signal, interferes with a carrier frequency of the broadcasting signal; sampling the digital input signal using a plurality of oversampling frequencies based on a local oscillator output signal and a separation signal to output a sampled digital signal based on the determination; and performing a pulse width modulation on the sampled digital signal.

### BRIEF DESCRIPTION OF THE DRAWINGS

The foregoing and other features of the invention will become more apparent from the descriptions of embodiments of the invention as illustrated in the accompanying drawings. The drawings are not necessarily to scale, with emphasis instead being placed upon illustrating the principles of the invention. Like reference characters refer to like elements throughout the drawings.

FIG. 1 is a schematic diagram illustrating a conventional audio system having a class-D amplifier.

FIG. 2 is a schematic diagram illustrating an audio system having a class-D amplifier according to an exemplary embodiment of the present invention.

FIG. 3 is a block diagram illustrating an exemplary digital signal processor included in the audio system of FIG. 2.

FIG. 4 is a block diagram illustrating an exemplary frequency detector included in the digital signal processor of FIG. 3.

FIG. 5 is a block diagram illustrating an exemplary sampling frequency controller included in the digital signal processor of FIG. 3.

FIG. 6 is a block diagram illustrating an exemplary sampler included in the digital signal processor of FIG. 3.

FIG. 7 is a diagram illustrating a waveform of a pulse width modulation signal when switching noise, which is generated in a pulse width modulator of FIG. 2, interferes with an AM broadcasting signal and when the switching noise does not interfere with an AM broadcasting signal.

FIG. 8A and FIG. 8B are diagrams illustrating energies of pulse width modulation signals generated at a fundamental frequency with certain harmonics components when a sampling is performed using X8 oversampling frequencies and X10 oversampling frequencies in the sampler of FIG. 6.

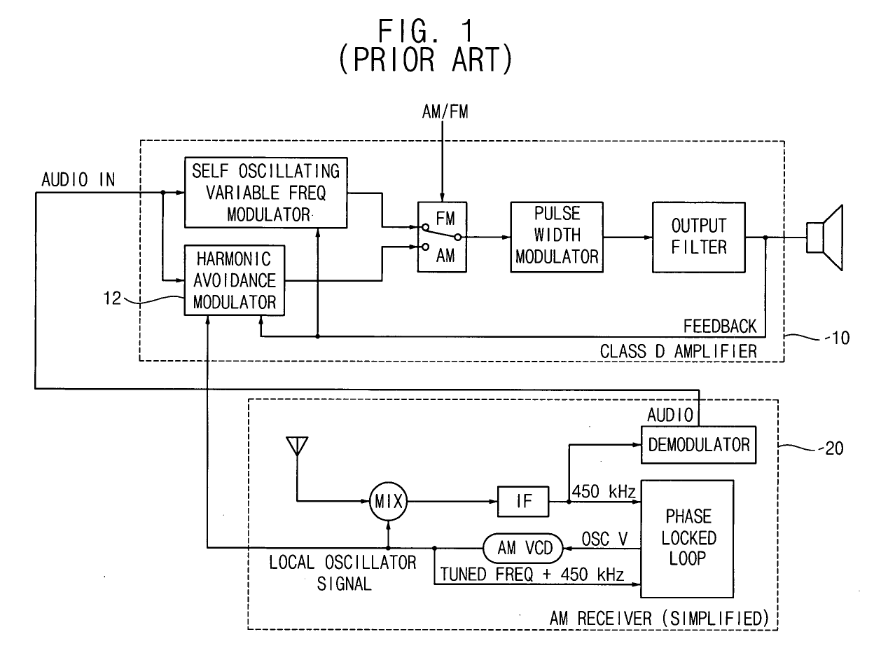

### DESCRIPTION OF EXEMPLARY EMBODIMENTS

Detailed embodiments of the present invention are disclosed herein. However, specific structural and functional details disclosed herein are merely presented for purposes of describing exemplary embodiments of the present invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

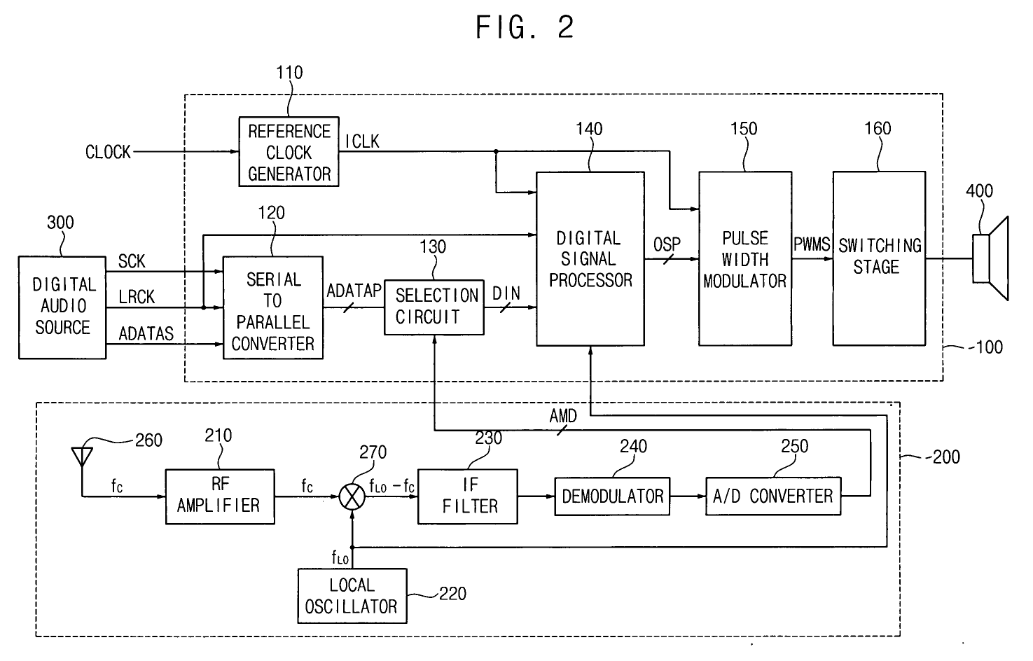

FIG. 2 is a schematic diagram illustrating an audio system having a class-D amplifier according to an embodiment of the present invention. Referring to FIG. 2, the audio system includes an AM receiver 200, a class-D amplifier 100, a digital audio source 300 and a speaker 400. A compact disc (CD) player may be used as the audio source 300.

The AM receiver 200 includes an antenna 260, a radio frequency (RF) amplifier 210, a mixer 270, an intermediate frequency (IF) filter 230, a demodulator 240, an analog to digital (A/D) converter 250, and a local oscillator 220.

The RF amplifier 210 receives a broadcasting signal having a carrier frequency f_{C} from the antenna 260 and amplifies the broadcasting signal. The local oscillator 220 adds a predetermined frequency to the carrier frequency f_{C} of the broadcasting signal to generate an oscillator output signal having the frequency f_{LO}. Here, the predetermined frequency is called an intermediate frequency, and may be about 455 kHz. The mixer 270 subtracts the carrier frequency f_{C} of the broadcasting signal from the frequency f_{LO} of the oscillator output signal to output a signal having a frequency of f_{LO}−f_{C}. The IF filter 230 filters and amplifies the signal having a frequency of f_{LO}−f_{C}. The output signal of the IF filter 230 is demodulated by the demodulator 240. The demodulated signal is converted into a digitized AM signal AMD by the A/D converter 250.

The class-D amplifier 100 includes a reference clock generator 110, a serial/parallel converter 120, a selection circuit 130, a digital signal processor 140, a pulse width modulator 150 and a switching stage 160.

The reference clock generator 110 receives an external clock signal CLOCK and generates an internal clock signal ICLK that is faster than the external clock signal CLOCK. The internal clock signal ICLK generally has a frequency that is at least ten times higher than a frequency of the external clock signal CLOCK.

The serial/parallel converter 120 receives a serial clock signal SCK, a left-right separation clock signal LRCK and a serial audio data signal ADATAS, and performs a serial/parallel conversion to generate a parallel audio data signal ADATAP.

The selection circuit 130 selects one of the parallel audio data signal ADATAP and the digitized AM signal AMD to generate a digital input signal DIN.

The digital signal processor 140 receives the internal clock signal ICLK, the left-right separation clock signal LRCK, the digital input signal DIN, and the local oscillator output signal f_{LO}, and samples the digital input signal DIN using one of a plurality of oversampling frequencies to generate a sampled signal OSP.

The pulse width modulator 150 receives the internal clock signal ICLK and the sampled signal OSP and performs a pulse width modulation and generates a pulse width modulation signal PWMS that has a pulse wave. The switching stage 160 receives the pulse width modulation signal PWMS from the pulse width modulator 150 and outputs an amplified audio signal. The amplified audio signal may be filtered by an output filter (not shown) and provided to the speaker 400.

The operation of the audio system having a class-D amplifier will now be described with reference to FIG. 2.

As shown in FIG. 2, the AM receiver 200 receives a broadcasting signal having a carrier frequency f_{C} from the antenna 260 and amplifies the broadcasting signal. The AM receiver ®transforms, amplifies and filters the amplified AM broadcasting signal into a signal having an intermediate frequency of about 450 kHz. The filtered analog signal is converted into the digitized AM signal AMD by the A/D converter 250.

The class-D amplifier 100 selects one of the parallel audio data signal ADATAP generated from the digital audio source 300 and the digitized AM signal AMD received from the antenna 260, and performs a pulse width modulation on the selected signal to output the pulse width modulated signal to the speaker 400. The class-D amplifier 100 receives the clock signals SCK and LRCK from the digital audio source 300 and the serial audio data signal ADATAS, and receives the digitized AM signal AMD and the local oscillator output signal f_{LO}. Further, the class-D amplifier 100 receives the external clock signal CLOCK to generate a fast internal clock signal ICLK that is used for counting frequencies of various signals.

The class-D amplifier 100 converts the serial audio data signal ADATAS to the parallel audio data signal ADATAP using the serial clock signal SCK and the left-right separation clock signal LRCK that is generated by dividing the serial clock signal SCK by a predetermined division ratio of (for example, 1:64). The frequency of the left-right separation clock signal LRCK is used as a sampling frequency f_{S} in the class-D amplifier 100.

The selection circuit 130 selects one of the parallel audio data signal ADATAP and the digitized AM signal AMD to output the selected signal as the digital input signal DIN.

The digital signal processor 140 samples the digital input signal DIN using one of the oversampling frequencies. In addition, the digital signal processor 140 detects the carrier frequency f_{C} of the broadcasting signal using the output signal of the local oscillator 220 having a frequency of f_{LO}. Further, the digital signal processor 140 determines whether noise, which is generated from the pulse width modulator 150, interferes with the AM broadcasting signal.

When noise interferes with the AM broadcasting signal, the digital signal processor 140 adjusts an oversampling frequency that is used for sampling the digital input signal DIN. When noise does not interfere with the AM broadcasting signal, the digital signal processor 140 does not adjust the oversampling frequency, but samples the digital input signal DIN using an oversampling frequency determined by the left-right separation clock signal LRCK.

When the audio source 300 is a compact disc (CD) type source, a frequency of the left-right separation clock signal LRCK, e.g., the sampling frequency fs may be about 32 kHz, about 44.1 kHz, or about 48 kHz. It should be understood by one of ordinary skill in the art, however, that a frequency of about 200 kHz may be used as the sampling frequency f_{S} to improve the quality of the audio system.

In Table 1, sampling frequencies, fundamental frequencies of a plurality of pulse width modulation signals PWMS, frequencies of harmonics of the pulse width modulation signals PWMS and frequency bandwidths of AM broadcasting signals are shown. In Table 1, the harmonics of the pulse width modulation signals PWMS represent second, third, fourth, fifth and sixth harmonics.

TABLE 1

| | | | | Frequency | | | |
|---|---|---|---|---|---|---|---|
| | | Fundamental | | of | | | |
| Sampling | | Frequency | | Harmonics | | AM Frequency | |
| Frequency | | of PWMS | | of PWMS | | Bandwidth | |
| 32 | kHz | 256 | kHz | 512 | kHz | | |
| | | | | 768 | kHz | 763˜773 | kHz |
| | | | | 1,024 | kHz | 1,019˜1,029 | kHz |
| | | | | 1,280 | kHz | 1,275˜1,285 | kHz |
| | | | | 1,536 | kHz | 1,531˜1,541 | kHz |
| 44.1 | kHz | 352.8 | kHz | 705.6 | kHz | 700.6˜710.6 | kHz |
| 88.2 | kHz | | | 1,058.4 | kHz | 1,053.4˜1,063.4 | kHz |
| 176.4 | kHz | | | 1,411.2 | kHz | 1,406.2˜1,416.2 | kHz |
| 48 | kHz | 384 | kHz | 768 | kHz | 763˜773 | kHz |
| 96 | kHz | | | 1,152 | kHz | 1,147˜1,157 | kHz |
| 192 | kHz | | | 1,536 | kHz | 1,531˜1,541 | kHz |

Referring to Table 1, the frequencies of the harmonics of the pulse width modulation signals PWMS overlap the frequency bandwidths of the AM broadcasting signals.

For example, when a sampling frequency fs of about 44.1 kHz is used, the pulse width modulation signal PWMS, in other words, the output signal of the pulse width modulator 150, has a frequency of about 352.8 kHz, which corresponds to about (e.g., 8 ×f_{S}). The pulse width modulation signal PWMS having a frequency of about 352.8 kHz has second harmonics of about 705.6 kHz (e.g., 2×352.8 kHz), third harmonics of about 1,058.4 kHz (e.g., 3×352.8 kHz), and fourth harmonics about 1,411.2 kHz (e.g., 4×352.8 kHz).

When the frequency of the harmonics of the pulse width modulation signal PWMS overlaps with the carrier frequency f_{C} of the AM broadcasting signal, interference may occur between the pulse width modulation signal PWMS and the AM broadcasting signal. When the pulse width modulation signal PWMS interferes with the AM broadcasting signal, the digital signal processor 140 included in the class-D amplifier 100 adjusts the oversampling frequency with which the input signal DIN is sampled. When the pulse width modulation signal PWMS does not interfere with the AM broadcasting signal, the digital signal processor 140 performs sampling using the oversampling frequency that is determined by the left-right separation clock signal LRCK without adjusting the oversampling frequency (for example, 8×f_{S}).

Accordingly, the digital audio amplifier according to an exemplary embodiment of the present invention changes the sampling rate to change the period of the pulse width modulation signal PWMS. Therefore, due to the transition of the pulse width modulation signal PWMS, interference of the pulse width modulation signal PWMS with the carrier frequency fc of the AM broadcasting signal may be decreased.

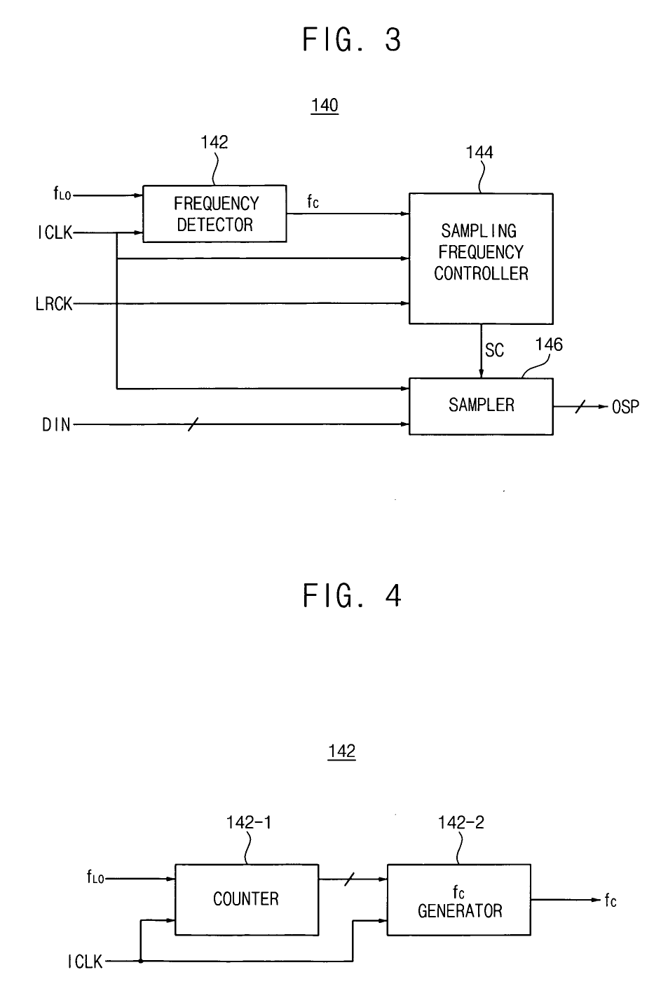

FIG. 3 is a block diagram illustrating an exemplary embodiment of the digital signal processor 140 included in the audio system of FIG. 2. Referring to FIG. 3, the digital signal processor 140 includes a frequency detector 142, a sampling frequency controller 144 and a sampler 146.

The frequency detector 142 receives the local oscillator output signal having a frequency of f_{LO} and the internal clock signal ICLK and detects and outputs a signal having the carrier frequency f_{C}. The sampling frequency controller 144 receives the signal having the carrier frequency f_{C}, the internal clock signal ICLK and the left-right separation clock signal LRCK, and determines whether switching noise, which is generated in the pulse width modulator 150 in FIG. 2, interferes with the AM broadcasting signal to generate a sampling control signal SC. The sampler 146 receives the internal clock signal ICLK, the digital input signal DIN and the sampling control signal SC, and generates the sampled signal OSP in response to the oversampling frequency.

FIG. 4 is a block diagram illustrating an exemplary embodiment of the frequency detector 142 included in the digital signal processor of FIG. 3. Referring to FIG. 4, the frequency detector 142 includes a counter 142-1 and an f_{C} generator 142-2. The counter 142-1 receives the local oscillator output signal having a frequency of f_{LO} and the internal clock signal ICLK and counts the frequency f_{LO} of the local oscillator output signal. The f_{C} generator 142-2 receives the internal clock signal ICLK and the output of the counter 142-1 and generates a signal having the carrier frequency f_{C}. The f_{C} generator 142-2 subtracts a predetermined frequency from the counted frequency of the output of the counter 142-1 to output the carrier frequency f_{C} of the AM broadcasting signal. As described above, the frequency f_{LO} of the local oscillator output signal may be higher than the carrier frequency f_{C} of an AM broadcasting signal by about 450 kHz.

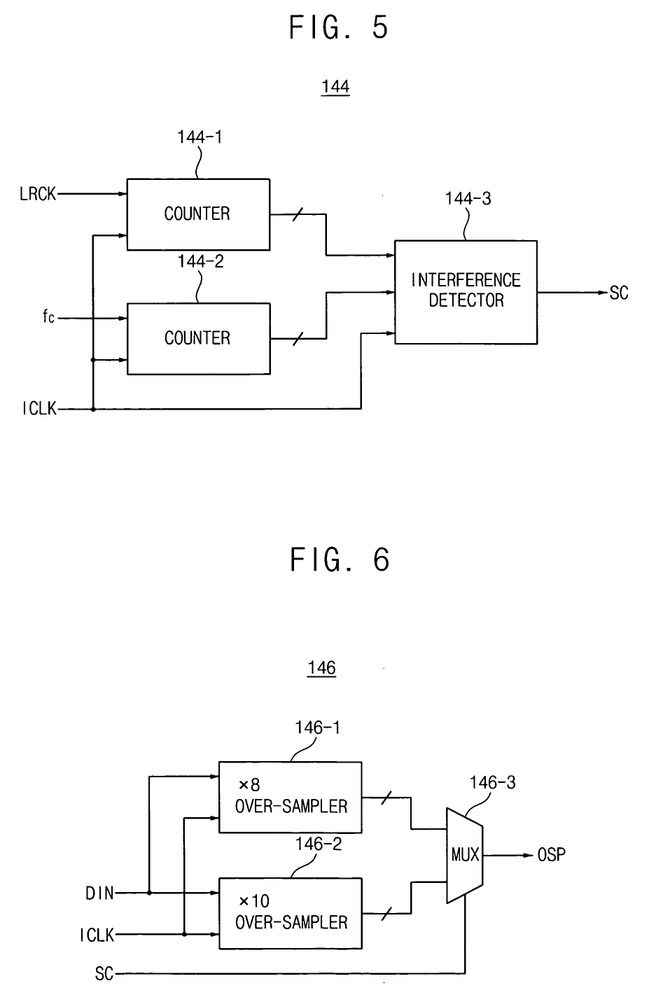

FIG. 5 is a block diagram illustrating an exemplary embodiment of the sampling frequency controller 144 included in the digital signal processor of FIG. 3. Referring to FIG. 5, the sampling frequency controller 144 includes counters 144-1 and 144-2 and an interference detector 144-3. The counter 144-1 receives the internal clock signal ICLK and the left-right separation clock signal LRCK to count a frequency of the left-right separation clock signal LRCK. The counter 144-2 receives the internal clock signal ICLK and the carrier frequency f_{C} to count the carrier frequency f_{C}. The interference detector 144-3 receives the output signals of the counters 144-1 and 144-2 and the internal clock signal ICLK to generate the sampling control signal SC.

For example, the interference detector 144-3 compares each frequency that is 8 times, 16 times and 24 times the frequency of the left-right separation clock signal LRCK with the carrier frequency f_{C} to output the sampling control signal SC. When there is a frequency component that is equal to the carrier frequency f_{C} among the frequency components of 8 times, 16 times and 24 times the frequency of the left-right separation clock signal LRCK, the sampling control signal SC may have a logic level of “1”. When there is no frequency component that is equal to the carrier frequency f_{C}, the sampling control signal SC may have a logic level of “0”.

FIG. 6 is a block diagram illustrating an exemplary embodiment of the sampler 146 included in the digital signal processor of FIG. 3. Referring to FIG. 6, the sampler 146 includes an X8 oversampler 146-1, an X10 oversampler 146-2 and a multiplexer 146-3. The X8 oversampler 146-1 receives the internal clock signal ICLK and the digital input signal DIN and samples the digital input signal DIN using an oversampling frequency of (e.g., 8×f_{S}) The X10 oversampler 146-2 receives the internal clock signal ICLK and the digital input signal DIN, and samples the digital input signal DIN using an oversampling frequency of (e.g., 10×f_{S}). The multiplexer 146-3 receives an output signal of the X8 oversampler 146-1 and an output signal of the X10 oversampler 146-2, and selects one of the output signal of the of X8 oversampler 146-1 and the output signal of the X10 oversampler 146-2, to generate the sampled signal OSP.

The operation of the digital signal processor 140 will now be described with reference to FIGS. 3-6.

As shown in FIG. 3, the digital signal processor 140 determines whether switching noise, which is generated in the pulse width modulator 150 in FIG. 2, interferes with the AM broadcasting signal to generate the sampling control signal SC. When the switching noise interferes with the AM broadcasting signal, the digital signal processor 140 enables the sampling control signal SC to adjust the oversampling frequency with which the input signal DIN is sampled. When the switching noise does not interfere with the AM broadcasting signal, the digital signal processor 140 performs sampling using the oversampling frequency that is determined by the left-right separation clock signal LRCK without adjusting the oversampling frequency.

For example, when the sampling frequency fs is about 44.1 kHz, the X8 oversampler 146-1 samples the digital input signal DIN using the oversampling frequency of about 352.8 kHz, which corresponds to about (e.g., 8×f_{S}). In a similar manner, the X10 oversampler 146-2 samples the digital input signal DIN using the oversampling frequency of about 441 kHz, which corresponds to about (e.g., 10×f_{S}).

For example, when a fundamental frequency and harmonics of the pulse width modulation signal PWMS interfere with the AM broadcasting signal, the sampling control signal SC becomes logic “1 ” and the output signal of the X10 oversampler 146-2 is output as the sampled signal OSP. When a fundamental frequency and harmonics of the pulse width modulation signal PWMS do not interfere with the AM broadcasting signal, the sampling control signal SC becomes logic “0” and the output signal of the X8 oversampler 146-1 is output as the sampled signal OSP.

It is to be understood by one of ordinary skill in the art that a variety of oversampling frequencies may be used by the digital signal processor 140 to perform sampling.

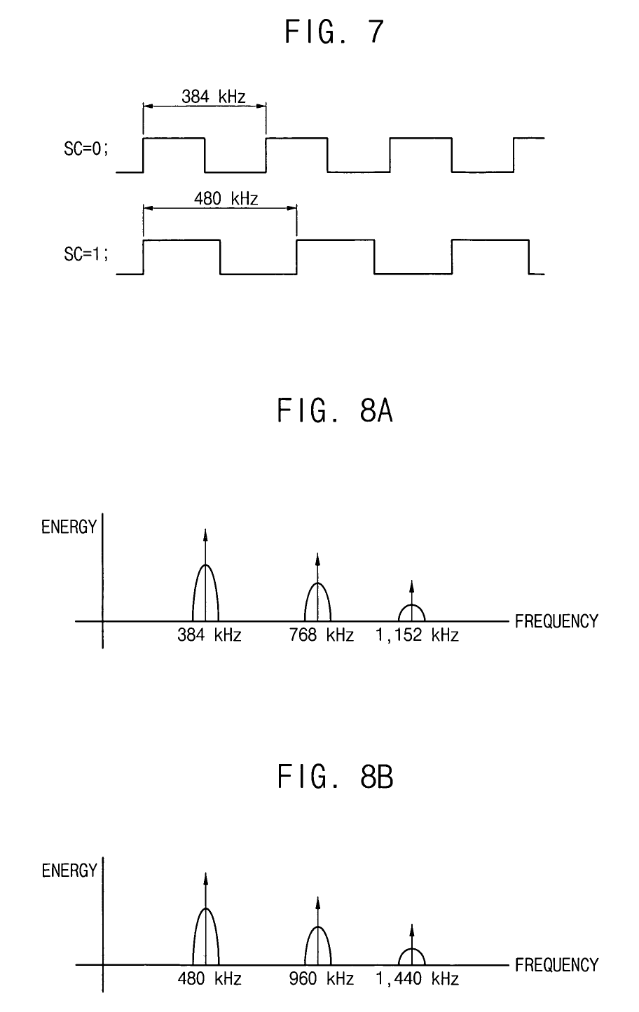

FIG. 7 is a diagram illustrating a waveform of a pulse width modulation signal when switching noise, which is generated, for example, in the pulse width modulator 150 of FIG. 2, interferes with an AM broadcasting signal and when the switching noise does not interfere with an AM broadcasting signal. In FIG. 7, oversampling frequencies are shown when the sampling frequency fs is about 48 kHz.

Referring to FIG. 7, when the sampling control signal SC is logic “0”, the pulse width modulation signal PWMS has a frequency of about 384 kHz, in other words, about (8×48 kHz). When the sampling control signal SC is logic “1”, the pulse width modulation signal PWMS has a frequency of about 480 kHz, in other words, about (10×48 kHz).

Accordingly, when the switching noise, which is generated from the pulse width modulator, interferes with an AM broadcasting signal, the class-D amplifier increases the frequency of the pulse width modulation signal PWMS to avoid interference by increasing the oversampling frequency.

FIG. 8A and FIG. 8B are diagrams illustrating energies of pulse width modulation signals generated at a fundamental frequency with certain harmonics components when a sampling is performed using X8 oversampling frequencies and X10 oversampling frequencies in, for example, the X8 oversampler 146-1 and X10 oversampler 146-2, respectively. FIG. 8A and FIG. 8B show the result of oversampling when the sampling frequency is about 48 kHz.

Referring to FIG. 8A and FIG. 8B, when switching noise, which is generated in, for example, the pulse width modulator 150 of FIG. 2, interferes with an AM broadcasting signal, a fundamental frequency component and its harmonics components are adjusted upward, as compared with a case in which the switching noise, which is generated in the pulse width modulator, does not interfere with the AM broadcasting signal.

In other words, when the switching noise, which is generated in the pulse width modulator, does not interfere with an AM broadcasting signal, energies of the fundamental frequency component and its harmonics components are distributed at frequencies of about 384 kHz, about 768 kHz and about 1,152 kHz. Further, when the switching noise, which is generated in the pulse width modulator, does not interfere with an AM broadcasting signal, energies of the fundamental frequency component and its harmonics components are distributed at frequencies of about 480 kHz, about 960 kHz and about 1,440 kHz.

In a digital audio amplifier according to an exemplary embodiment of the present invention, a digital signal processor determines whether switching noise, which is generated in a pulse width modulator, interferes with an AM broadcasting signal. When switching noise interferes with an AM broadcasting signal, a carrier frequency of the AM broadcasting signal can be reduced by adjusting an oversampling frequency of the digital audio amplifier.

Accordingly, an audio system including a digital audio amplifier according to an exemplary embodiment of the present invention can receive good quality AM broadcasting signals. Further, the digital audio amplifier can be easily integrated into electronic products such as a stereo receiver.

While the exemplary embodiments of the present invention have been described herein in detail, it should be understood that various changes, substitutions and alterations can be made herein without departing from the scope of the invention as defined by appended claims.

What is claimed is:

1. A digital audio amplifier, comprising:
a selection circuit configured to select one of an audio data signal and a digitized broadcasting signal to output a digital input signal;
a digital signal processor configured to sample the digital input signal using one of a plurality of oversampling frequencies based on a local oscillator output signal and a separation signal to output a sampled digital signal depending upon whether noise, which is generated from a fundamental frequency component and harmonics components of a pulse width modulation signal, interferes with a carrier frequency of the broadcasting signal; and
a pulse width modulator configured to perform a pulse width modulation on the sampled digital signal.

2. The digital audio amplifier of claim 1, further comprising:
a reference clock generator configured to generate an internal clock signal having a frequency higher than a frequency of an external clock signal.

3. The digital audio amplifier of claim 2, wherein the audio data signal is generated by a CD player.

4. The digital audio amplifier of claim 3, wherein the separation signal is a left-right separation clock signal generated in the CD player.

5. The digital audio amplifier of claim 4, wherein the digital signal processor comprises:
a frequency detector configured to detect a signal having a carrier frequency of the broadcasting signal based on the local oscillator output signal and the internal clock signal;
a sampling frequency controller configured to determine whether the noise interferes with the carrier frequency of the broadcasting signal to generate a sampling control signal; and
a sampler configured to sample the digital input signal using one of the oversampling frequencies in response to the sampling control signal.

6. The digital audio amplifier of claim 5, wherein one of the oversampling frequencies is determined based on the left-right separation clock signal when the noise does not interfere with the broadcasting signal.

7. The digital audio amplifier of claim 5, wherein one of the oversampling frequencies is n (where n is a positive integer) times higher than the frequency of the left-right separation clock signal when the noise does not interfere with the broadcasting signal.

8. The digital audio amplifier of claim 7, wherein n is eight.

9. The digital audio amplifier of claim 5, wherein one of the oversampling frequencies is higher than an oversampling frequency, which is used by the sampler when the noise does not interfere with the broadcasting signal, when the noise interferes with the broadcasting signal.

10. The digital audio amplifier of claim 9, wherein one of the oversampling frequencies is ten times higher than the frequency of the left-right separation clock signal when the noise interferes with the broadcasting signal.

11. The digital audio amplifier of claim 5, wherein the frequency detector comprises:
a counter configured to count a frequency of an output signal of the local oscillator in response to the internal clock signal; and
a carrier frequency generator configured to subtract a predetermined frequency from the counted frequency of the output signal of the local oscillator to output the carrier frequency of the broadcasting signal.

12. The digital audio amplifier of claim 11, wherein the predetermined frequency is in a range from about 400 kHz to about 460 kHz.

13. The digital audio amplifier of claim 5, wherein the sampling frequency controller comprises:
a first counter configured to count a frequency of the left-right separation clock signal in response to the internal clock signal;
a second counter configured to count the carrier frequency of the broadcasting signal in response to the internal clock signal; and
an interference detector configured to determine whether the noise interferes with the carrier frequency of the broadcasting signal to generate the sampling control signal.

14. The digital audio amplifier of claim 5, wherein the sampler comprises:
a first oversampler configured to sample the digital input signal in response to a first oversampling frequency;
a second oversampler configured to sample the digital input signal in response to a second oversampling frequency; and
a selection circuit configured to select one of an output signal of the first oversampler and an output signal of the second oversampler in response to the sampling control signal.

15. The digital audio amplifier of claim 1, further comprising:
a switching stage configured to generate an amplified audio signal in response to the pulse width modulation signal.

16. An audio system, comprising:
a receiver configured to receive a broadcasting signal and to generate a digitized broadcasting signal; and
a digital audio amplifier, wherein the digital audio amplifier comprises:
a selection circuit configured to select one of an audio data signal and the digitized broadcasting signal to output a digital input signal; and
a digital signal processor configured to sample the digital input signal using one of a plurality of oversampling frequencies based on a local oscillator output signal and a separation signal to output a sampled digital signal depending upon whether noise, which is generated from a fundamental frequency component and harmonics components of a pulse width modulation signal, interferes with a carrier frequency signal of the broadcasting signal; and
a pulse width modulator configured to perform a pulse width modulation on the sampled digital signal.

17. The audio system of claim 16, wherein the separation signal is a left-right separation clock signal generated from an audio source.

18. The audio system of claim 16, wherein the digital audio amplifier further comprises:
a switching stage configured to generate an amplified audio signal in response to the pulse width modulation signal.

19. A method of amplifying an audio signal, comprising:
selecting one of an audio data signal and a digitized broadcasting signal to output a digital input signal;
determining whether noise, which is generated from a fundamental frequency component and harmonics components of a pulse width modulation signal, interferes with a carrier frequency of the broadcasting signal;
sampling the digital input signal using one of a plurality of oversampling frequencies based on a local oscillator output signal and a separation signal to output a sampled digital signal based on the determination; and
performing a pulse width modulation on the sampled digital signal.

20. The method claim 19, wherein the separation signal is a left-right separation clock signal generated from an audio source.

21. The method of claim 20, wherein determining whether noise interferes with the carrier frequency signal of the broadcasting signal comprises:
detecting a signal having a carrier frequency of the broadcasting signal based on the local oscillator output signal and an internal clock signal;
determining whether the noise interferes with the carrier frequency of the broadcasting signal;
generating a sampling control signal of which a logic state depends upon the determination; and
sampling the digital input signal using one of the oversampling frequencies determined by the sampling control signal.

22. The method of claim 21, wherein detecting a signal having a carrier frequency of the broadcasting signal comprises:
counting a frequency of an output signal of the local oscillator in response to the internal clock signal; and
subtracting a predetermined frequency from the counted frequency of the output signal of the local oscillator to output the carrier frequency of the broadcasting signal.

23. The method of claim 21, wherein determining whether noise interferes with the carrier frequency signal of the broadcasting signal comprises:
counting a frequency of the left-right separation clock signal;
counting the carrier frequency of the broadcasting signal; and
determining whether the noise interferes with the carrier frequency of the broadcasting signal in response to the frequency of the counted left-right separation clock signal and the carrier frequency of the broadcasting signal.
